(19) United States
(12) Patent Application Publication
(10) Pub. No.: US 2006/0234855 A1
(43) Pub. Date: Oct. 19, 2006

(54) Preparation of solid oxide fuel cell electrodes by electrodeposition

(76) Inventors: Raymond J. Gorte, Narberth, PA (US); John M. Vohs, Newtown Square, PA (US); Michael D. Gross, Philadelphia, PA (US); Benjamin Lin, Emmaus, PA (US); Shung-Ik Lee, Devon, PA (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 11/247,998

(22) Filed: Oct. 12, 2005

Related U.S. Application Data
(60) Provisional application No. 60/617,214, filed on Oct. 12, 2004.

(51) Int. Cl. H01M 4/88; H01M 4/86; C25C 1/08; C25C 1/10; C25C 1/12

(52) U.S. Cl. 502/101; 429/45; 205/183; 205/261; 205/269; 205/283; 205/291

(57) ABSTRACT

A method for preparing an electrode for a solid oxide fuel cell, in which a conductive material, such as a metal, is electrodeposited onto a porous electrode comprising a conductive material and an electrolyte. The method allows metals to be added directly to a porous electrode without the need for subsequent reduction steps. The method also permits the conductive materials to be deposited in controlled, layered structures, thereby enabling the use of different metals to achieve desired properties.

The present invention claims priority to U.S. Provisional Application No. 60/617,214 filed Oct. 12, 2004 the contents of which are incorporated herein by reference in their entirety.

### BACKGROUND

1. Field of the Embodiments

Embodiments relate to solid oxide fuel cell (SOFC) electrodes, and methods of making the electrodes. Specifically, the electrodes are prepared by forming a porous electrode containing a conductive material, and then coating the porous electrode with a conductive material by electrodeposition.

2. Description of Related Art

Solid oxide fuel cells have grown in recognition as a viable high temperature fuel cell technology. There is no liquid electrolyte, which eliminates metal corrosion and electrolyte management problems typically associated with the use of liquid electrolytes. Rather, the electrolyte of the cells is made primarily from solid ceramic materials that are capable of surviving the high temperature environment typically encountered during operation of solid oxide fuel cells. The operating temperature of greater than about 600° C. allows internal reforming, promotes rapid kinetics with non-precious materials, and produces high quality by-product heat for cogeneration or for use in a bottoming cycle. The high temperature of the solid oxide fuel cell, however, places stringent requirements on its fabrication materials. Because of the high operating temperatures of conventional solid oxide fuel cells (approximately 600 to 1000° C.), the materials used to fabricate the respective cell components are limited by chemical stability in oxidizing and reducing environments, chemical stability of contacting materials, conductivity, and thermomechanical compatibility.

The general operating principles of a solid oxide fuel cell (SOFC) involve introducing air to the cathode, usually a composite of Sr-doped LaMnO₃ (LSM) and yttria-stabilized zirconia (YSZ), where the O₂ is reduced according to the half-cell reaction (1):
O₂+4 e⁻=2O²⁻ (1)

The O²⁻ anions are transported through the electrolyte, an electronically insulating but ionically conductive membrane, often yttria-stabilized zirconia (YSZ), to the anode. The anode is frequently composed, at least partially, of a material that is compatible with or the same as the electrolyte, such as porous YSZ. In principle, the O²⁻ anions can react with hydrocarbon fuels at the anode according to reaction (2):
CₙHₘ+(2n+m/2)O²⁻=n CO₂+m/2 H₂O+(4n+m)e⁻ (2)

However, in most cases, the hydrocarbon must first be reformed to syngas, a mixture of CO and H₂, before sending it to the anode, so that the actual half-cell reaction is reaction (3):
H₂+O²⁻=H₂O+2 e⁻ (3)

Because the performance of typical SOFC electrodes is poor with CO, CO in the syngas mixture is believed to react to CO₂ primarily through water-gas shift that produces more H₂. See Y. Jiang and A. V. Virkar, JECS, 150, A942 (2003).

The development of practical electrodes for directly utilizing methane and other hydrocarbon fuels in SOFC, without first reforming the methane to syngas, would provide significant advantages that could well speed commercialization of these devices. The most common anode material for a SOFC, a ceramic-metallic (cermet) composite of Ni and YSZ, however, cannot be used for this direct oxidation process.

The reason that CH₄ and other hydrocarbon fuels cannot be oxidized directly in a SOFC with a Ni cermet is that Ni catalyzes carbon-fiber formation, a process that has been studied intensely because of its importance in steam-reforming catalysis (R. T. K. Baker, M. A. Barber, P. S. Harris, S. D. Feates, and R. J. Waite, J. Catal. 26, 51 (1972); R. T. K. Baker, P. S. Harris, and S. Terry, Nature, 253, 37 (1975)) and in dry corrosion, also known as “dusting” (Chun C. M.; Mumford J. D.; Ramanarayanan T. A. In SOFC VI; Singhal, S. C.; Dokiya, M., Eds.; The Electrochemical Society Proceedings Series PV 1999-19, p 621; Toh, C. H.; Munroe P. R.; Young D. J.; Foger K. Mater. High Temp. 20, 129 (2003)). For large-scale systems, the reforming can be performed internally so that heat for reforming can be supplied by losses in the fuel cell. This makes for a highly efficient process. (Note that the surface areas of the electrodes are typically low, so that, when internal reforming is used, most of the reaction is not performed on the anode itself.) However, for smaller-scale systems, even at 5 kW, it is often necessary to do autothermal reforming, where a significant fraction of the methane is reformed according to reaction (4):
CH4+½O2=CO+2H2 (4)

Reaction (4) results in significant energy losses for high-temperature fuel cells. First, it causes a dilution of the fuel through the addition of 2.5 moles of N₂ for every mole of CH₄ that is oxidized. The targeted fuel utilization (the fuel conversion) is usually chosen based on the minimum fuel concentration at which the cell can operate, so that this dilution is important. Second, while the enthalpy change for oxidation of CO+2H₂ (the product of Reaction (4)) is only 5% lower than the enthalpy change for oxidation of CH₄, the change in Gibbs Free Energy (AG) for oxidation of CO+2H₂ is 28% lower than that for oxidation of CH₄ at 800° C. This distinction is critical because the theoretical efficiency of a fuel cell for generation of electricity is AG/AH. The decrease in AG for the reformate implies a significant loss in available energy for the fuel cell. Another way of looking at this is that CO and H₂ have a lower standard potential than CH₄ at 800° C. and electrochemical oxidation of CO+2H₂ delivers only 6 electrons compared to 8 for CH₄.

It has recently been shown that it is possible to use hydrocarbon fuels directly when Ni is replaced with an electronic conductor, e.g., Cu or a Cu-containing metal mixture, that does not catalyze the formation of carbon fibers. U.S. Pat. Nos. 6,589,680; 6,811,904; 6,844,099; and 6,939,637, the disclosures of which are incorporated by reference herein in their entireties. For example, the Cu or Cu-containing mixture provides electronic conductivity and possibly catalytic activity in the electrode. However, Cu cermets cannot be prepared using the high-temperature methods commonly used with Ni cermets because of the low melting temperatures of Cu and Cu-containing mixtures. Ni—YSZ cermets most often are prepared by high-temperature sintering of mixed NiO and YSZ powders, followed by reduction of the NiO to Ni metal. The best performance usually is achieved when the firing temperature is greater than 1300° C. to properly sinter the YSZ in the electrode to the YSZ in the electrolyte. The melting temperature of Cu is 1083° C., much lower than this firing temperature. It also is difficult to prepare electrodes containing some other metals of interest, such as Cr, because their oxides cannot be reduced to the metallic form with reasonable preparation conditions.

To avoid high-temperature processing, it is possible to add the electroactive components to a porous electrode material after it has been sintered. This two-step process permits the use of high firing temperatures for sintering the ionic conductor to the electrolyte and lower temperatures for the remaining components. For example, the addition of the electronic and catalytic components may be accomplished by impregnation of the electrolyte with a solution of the relevant materials. In general, the porous electrode is dipped in an aqueous solution of metal salts at room or low temperature. The anode is removed from solution and allowed to dry, which results in a coating of the salts (typically nitrate salts) in the pores. The salts are heated in air to decompose the nitrates and form oxides, which are then reduced in H₂ to leave a coating of metal inside of the pores. While such an impregnation process allows unprecedented control over composition and structure, the process can be tedious, requiring many impregnation steps. Also, the procedure does not allow the addition of some metals such as Cr, since CrOₓ can not be reduced under reasonable manufacturing conditions.

Recently, processes have been disclosed for a method of depositing catalysts on electrodes by various means. For example, U.S. Pat. No. 6,258,239 discloses a process for manufacturing an electrode for a Proton Exchange Membrane (PEM) fuel cell or an electrochemical energy converter, whereby an ion-exchange polymer is applied to one face of an electrode substrate. An electrocatalyst is then applied to the substrate by electrochemical deposition, preferably from a solution containing one or more complexes or salts of the electrocatalyst. The electrochemical deposition occurs by application of a voltage between a pair of electrodes, one of which is the electrode under preparation. The voltage between the two electrodes is controlled by controlling the potential of the working electrode. A pulsed voltage profile is applied across the two electrodes during the electrodeposition process.

U.S. Pat. No. 6,080,504 discloses preparing a gas diffusion electrode for a proton exchange membrane fuel cell by electrodeposition of a catalytic metal in nanocrystalline form on a substrate by contacting an electrically conductive substrate and a counterelectrode with a plating bath containing ions of a metal to be deposited on the substrate and passing a pulsed electric current between the substrate and counterelectrode having pulses that are cathodic with respect to the substrate and have a short on-time and/or a short duty cycle with a frequency from about 10 hertz to about 5000 hertz. In a preferred embodiment the electric current is a modulated reversing electric current having pulses that are cathodic with respect to the substrate and pulses that are anodic with respect to the substrate, the cathodic pulses having a short on-time and/or short duty cycle, the charge transfer ratio of the cathodic pulses to the anodic pulses being greater than one, and the frequency of the pulses ranging from about 10 hertz to about 5 kilohertz.

The description herein of certain advantages and disadvantages of various features, embodiments, methods, and apparatus disclosed in other publications is not intended to limit the scope of the present embodiments. Indeed, the preferred embodiments may include some or all of the features, embodiments, methods, and apparatus described above without suffering from the same advantages.

### SUMMARY

Based on the foregoing, there remains a need in the art for a SOFC capable of directly oxidizing methane and other hydrocarbon fuels, without first reforming the methane to syngas. These direct-utilization SOFCs should be capable of converting chemical to electrical energy at very high efficiencies. Preferably, the SOFC contains electrodes that contain conductive materials that will be stable at higher temperatures, and that are capable of enhancing catalytic activity for CH₄ activation within the electrode, preferably without using precious metals.

There also remains a need in the art for a reliable, inexpensive process for manufacturing the components of a SOFC. There exists a need to develop such a process to produce a SOFC capable of directly oxidizing methane and other hydrocarbon fuels, without reforming the methane to syngas, as well having other advantageous properties. Embodiments described herein satisfy these needs.

In accordance with a feature of an embodiment, there is provided a method of preparing a SOFC electrode by electrodeposition of a conductive metal into a porous electrolyte material containing conductive materials. The method allows the metals to be added directly, without need for subsequent reduction steps. This reduces the number of manufacturing steps required to add the metals.

In addition, the embodiments permit the use of metals that typically are or would be difficult to reduce from their oxides, such as Cr. These metals can be added directly from solution. Moreover, the embodiments permit the metals to be deposited in controlled, layered structures, thereby enabling the use of different metals to achieve different properties. For example, Cu coatings can be used to passivate the tendency of Co or Cr, which have high melting temperatures and a lower tendency to sinter, against carbon fiber formation (Co) or oxidation (Cr).

A feature of an embodiment therefore is a method of making a SOFC electrode that includes forming an electrolyte layer, depositing on the electrolyte layer an electrode layer, thereby forming a composite comprised of a porous electrode containing a conductive material, and a dense electrolyte. The method further includes electrodepositing a conductive material on or in the porous electrode.

In one embodiment, the porous electrode containing a conductive material (or a precursor to the conductive material, such as NiO which could be reduced to the conductive metallic Ni) is prepared by mixing a conductive material and an electrolyte material together, and then depositing the mixture onto a separate electrolyte material layer. The two layers then are cofired or cosintered to form a dense electrolyte and porous electrode containing a conductive material. The method further includes electrodepositing a conductive material on the porous electrode.

In another embodiment, the porous electrode containing a conductive material is prepared by depositing on an electrolyte material layer, a second electrolyte material layer containing pore formers, and then co-firing or co-sintering the two layers to produce a dense electrolyte layer and a porous layer. The method then includes impregnating the porous layer with a conductive material to form a porous electrode containing a conductive material. The method further includes depositing a conductive material suitable for use in an electrode in or on the porous electrode by electrodeposition.

Additional embodiments include a method of making a SOFC by preparing a cathode, an anode and an electrolyte. The cathode and the anode can be prepared in the same or similar manner, each or only one being formed using the electrodeposition method described herein.

Other embodiments include an electrode prepared by the electrodeposition method, and a SOFC containing at least one electrode prepared by the electrodeposition method.

These and other objects, features, and advantages of the embodiments will appear more fully from the following detailed description of the preferred embodiments.

### BRIEF DESCRIPTION OF THE DRAWINGS

The embodiments presented herein can be understood more completely by reading the following detailed description, in conjunction with the accompanying drawings, in which:

FIG. 1 is a schematic of a basic electrodeposition process;

FIG. 2 is a photograph showing the effects of exposure of a Ni cermet and a Cu-electroplated Ni cermet to CH₄ at 800° C. for 3 hours;

FIG. 3 is a photograph of six Cu—Co—YSZ composites having 20 wt-% metal after reduction in H₂ and exposure to CH₄ at 1073 K for 2 h: (a) 100% Cu; (b) 90% Cu, 10% Co; (c) 70% Cu, 30% Co; (d) 50% Cu, 50% Co; (e) 10% Cu, 90% Co; and (f) 100% Co;

FIG. 4 is a graph of the EDS results showing the concentration of Cu in a Cu-electroplated Ni cermet;

FIG. 5 is an SEM image of a YSZ structure prepared by laminating 5 separate tapes, some containing pore formers, to produce well-connected porous-dense-porous layers;

FIG. 6 is a schematic of a system used to measure potential inside the pores of an electrode during electrodeposition;

FIG. 7 is a graph showing the relationship between potential difference and concentration of CuSO₄ in the electroplating solution;

FIG. 8 is a graph showing the relationship between potential difference and concentration of H₂SO₄ in the electroplating solution;

FIG. 9 is a photograph of three Cu—Ni bimetallic composites after exposure to methane at 800° C. for 3 hours;

FIG. 10 is a graph of the EDS results showing the concentration of Cr in a Cr-electroplated Ni cermet;

FIG. 11 is a graph showing the ohmic resistance of two Cu—Cr anodes, determined from impedance spectra at 700° C. in humidified H₂, following pretreatment for one hour at various temperatures;

FIG. 12 is a graph showing the ohmic resistance of a fuel cell with a Cu—Cr—YSZ cermet at 900° C. as a function of time;

FIG. 13 is a graph showing the ohmic resistance of a fuel cell with a Cu—Cr—YSZ cermet at 800° C. in humidified H₂; and

FIG. 14 is a graph showing the ohmic resistance of a fuel cell with a Cu—Cr—YSZ cermet at 800° C. in CH₄.

### DETAILED DESCRIPTION OF PREFERRED EMBODIMENTS

The terminology used herein is for the purpose of describing particular embodiments only, and is not intended to limit the scope of the present invention. As used throughout this disclosure, the singular forms “a,” “an,” and “the” include plural reference unless the context clearly dictates otherwise. Thus, for example, a reference to “a solid oxide fuel cell” includes a plurality of such fuel cells in a stack, as well as a single cell, and a reference to “a cathode” is a reference to one or more cathodes and equivalents thereof known to those skilled in the art, and so forth.

Unless defined otherwise, all technical and scientific terms used herein have the same meanings as commonly understood by one of ordinary skill in the art to which this invention belongs. Although any methods and materials similar or equivalent to those described herein can be used in the practice or testing of the present invention, the preferred methods, devices, and materials are now described. All publications mentioned herein are cited for the purpose of describing and disclosing the various anodes, electrolytes, cathodes, and other fuel cell components that are reported in the publications and that might be used in connection with the invention. Nothing herein is to be construed as an admission that the invention is not entitled to antedate such disclosures by virtue of prior invention.

The various embodiments described herein are directed to a method of fabrication of electrodes for direct oxidation of hydrogen, methane, or other higher hydrocarbons, in solid oxide fuel cells (SOFC). Generally, a SOFC is constituted of an air electrode (cathode), a fuel electrode (anode), and a solid oxide electrolyte provided between these two electrodes. In a SOFC, the electrolyte is in solid form. Typically, the electrolyte is made of a nonmetallic ceramic, such as dense yttria-stabilized zirconia (YSZ) ceramic, that is a nonconductor of electrons, which ensures that the electrons must pass through the external circuit to do useful work. As such, the electrolyte provides a voltage buildup on opposite sides of the electrolyte, while isolating the fuel and oxidant gases from one another. The anode and cathode are generally porous, with the cathode oftentimes being made of doped lanthanum manganite (e.g., LSM), doped lanthanum ferrate (LSF), or doped lanthanum cobaltate (LSCo). In the solid oxide fuel cell, hydrogen or a hydrocarbon is commonly used as the fuel and oxygen or air is used as the oxidant.

The most common anode material for SOFC is a ceramic-metallic (cermet) composite of Ni and YSZ. N. Q. Minh, J. Am. Ceram. Soc. 76, 563 (1993). The Ni provides the required electronic conductivity and catalytic activity for H₂ oxidation, as well as promoting the water-gas-shift reaction. The YSZ in the composite maintains thermal stability of the electrode against Ni sintering and provides paths for transport of O²⁻ ions from the electrolyte into the electrode. These ion-conducting pathways are crucial for increasing the length of the three-phase boundary (TPB), the zone where the electrochemical reaction occurs. C. W. Tanner, K.-Z. Fung, A. V. Virkar, JECS, 22, 144 (1997); Virkar, A. V.; Fung, K. Z.; Tanner, C. W. U.S. Pat. No. 5,543,239 (1996). (The TPB is the region where the gas phase, the ionic conductor, and the electronic conductor meet.) However, as discussed above, hydrocarbon fuels cannot be oxidized directly in a SOFC with a Ni-based electrode, because Ni catalyzes carbon fiber formation. Several attempts have been made to optimize the performance of Ni-based electrodes for direct utilization of hydrocarbons such as by modifying the operating conditions, substituting other electronically conductive materials for Ni, and adding catalysts. However, none of these approaches has been commercially successful.

The development of practical electrodes for directly oxidizing carbon containing fuels (e.g., methane) in solid oxide fuel cells (SOFC), without first reforming the fuels (i.e., from methane to syngas), provides significant advantages that could well speed commercialization of these devices. Direct-utilization fuel cells are capable of converting chemical to electrical energy at very high efficiencies. Removing the need for a reformer also leads to simplification of the fuel-cell system. Direct utilization of methane could also lead to the commercialization of an innovative new method for H₂ generation, natural gas assisted steam electrolysis (NGASE), that has been developed at Lawrence Livermore National Labs, as disclosed in U.S. Pat. No. 6,051,125 to Pham, et al., the disclosure of which is incorporated herein by reference in its entirety. See also, J. Martinez-Frias, A.-Q. Pham, S. M. Aceves, Int. J. Hydrogen Energy, 28, 483 (2003). While electrodes capable of direct utilization of methane have been demonstrated by a number of groups, either the performance or the stability of materials that have been tested to date has been insufficient for practical use.

The present embodiments provide a method for the preparation of SOFC electrodes by electrodeposition of conductive materials (such as Cu and other metals) into a porous electrolyte material (such as YSZ), so that at least a portion of the conductive material is deposited into the pores of the electrode.

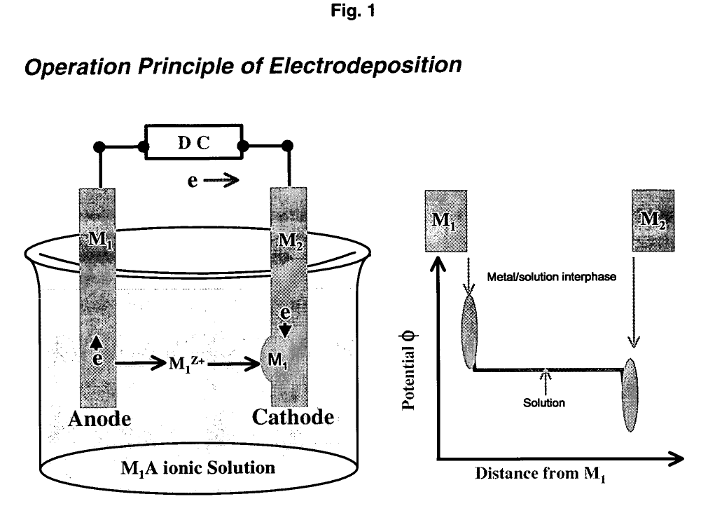

Generally speaking, elecrodeposition (also known as “electroplating”) is the process of producing a coating, usually metallic, on a surface by using an electric current. The deposition of a metallic coating may be achieved by putting a negative charge on the electrode to be coated, immersing it into a solution (the “plating” solution) that contains a salt of the metal to be deposited. The metallic ions of the salt carry a positive charge and are therefore attracted to the negatively charged electrode. When the metallic ions reach the surface of the electrode, the electrode provides electrons to the positively charged ions to reduce the ions to metallic form. An exemplary apparatus for performing electrodeposition is illustrated in FIG. 1. On the right side of the figure, a chart shows the potential as a function of distance from the electrodes (M). The figure shows that most of the potential drop in the solution occurs at the electrode.

The method of this embodiment provides several benefits. For example, the method allows metals to be added directly to the electrode, without need for subsequent reduction steps, thereby reducing the number of steps required to add the metals. In addition, the method permits the use of metals that typically are or would be difficult to reduce from their oxides, such as Cr. These metals can be added directly from solution. Moreover, the method permits the metals to be deposited in controlled, layered structures, thereby enabling the use of different metals to achieve different properties. For example, Cu coatings can be used to passivate the tendency of Co or Cr, which have high melting temperatures and a lower tendency to sinter, against carbon fiber formation (Co) or oxidation (Cr). Although Cr and Co are of particular interest because of their high melting temperature, electrodeposition, with its demonstrated ability to control structure, could be used for a wide variety of materials in the manufacturing of electrodes for SOFC. The electrodeposition may be used to deposit one or more conductive materials on the porous electrode.

The particular electrodeposition technique utilized is not critical to the embodiments described herein. Rather, any electrodeposition technique now known or later discovered can be used in the embodiments to deposit a conductive material into the pores of the porous electrode, using the guidelines provided herein.

While electrodeposition of a conductive material into an electrode provides numerous benefits, electroplating a porous material, such as the porous electrolyte material of the electrode, poses some difficulties. In particular, there is a strong tendency for the metals to deposit only on the external surface of a porous material, and not penetrate the pores. Therefore, in order to deposit uniformly onto a porous substrate, it is preferable that the concentration of the ions be uniform in the solution, throughout the porous material, and that the potential in the fluid is uniform. Furthermore, it is preferable that the rate of the deposition be limited by the surface reaction, not by the potential across the surface bilayer or by the diffusion of ions in solution. By using the method of the embodiments, it is possible, for example, to deposit nearly 60 wt % Cu into a porous YSZ material nearly 1 cm thick, where nearly all of the Cu is inside the material.

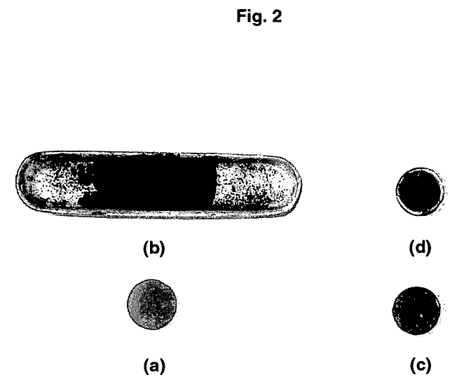

Embodiments include electroplating an electrode to provide an electrode having precise layering of materials that provide the electrode with unique properties. For example, as provided above, traditional Ni-based electrodes provide the required electronic conductivity and catalytic activity for H₂ oxidation, but are not suitable for the oxidation of hydrocarbon fuels because of their tendency toward carbon formation. However, when a Ni-cermet is electroplated with Cu, the Cu passivates the Ni cermet towards carbon formation. FIG. 2 shows a comparison of several exemplary Ni—YSZ cermets, with and without Cu coating, before and after exposure to a fuel. Sample (a) on the bottom left is an unplated Ni—YSZ cermet after heating in H₂. Sample (b) on the top left is a similar Ni—YSZ cermet after heating in dry methane at 800° C. for 3 hours, showing that the Ni cermet is transformed into a “carbonaceous” powder. In comparison, the photos on the right show an exemplary Cu-plated Ni—YSZ cermet. Sample (c) on the bottom right is of a Ni—YSZ cermet after electroplating. Sample (d) on the top right is a similar sample, after heating in dry methane at 800° C. for 3 hours. These photos show that the Cu-plating effectively passivates the Ni cermet towards carbon formation in methane. After treating in dry methane, Cu-plated Ni cermet appears to be essentially unaffected by the methane treatment.

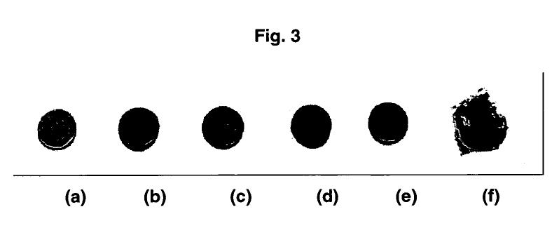

Another exemplary embodiment provides electroplating Cr into a porous Ni or Cu cermet. One benefit in adding Cr is to increase the thermal stability of the electrode. For example, at higher temperatures, Cu sintering causes the cermet anode to lose conductivity. Cr could potentially impart significant resistance towards sintering because of its very high melting temperature, 400 degrees higher than that of Ni and 800 degrees higher than that of Cu. While the surface of Cr will tend to oxidize and its hydroxides can even vaporize under anode conditions, Cr layers can be coated with Cu, with the resultant material having properties much like the Cu—Co bimetallics shown in FIG. 3. In this case, Cu would provide the necessary “inertness” and Cr would stabilize the metal phase towards sintering. Another potential issue with Cr is that it can oxidize in steam. Therefore in particular applications where Cr is exposed to steam, it is preferable to coat the Cr with a layer of Cu, effectively sandwiching the Cr. It has been shown that Cu tends to wet Cr metal. Layered structures, made from alternating layers of Cu and Cr, each 25 nm thick, are stable to at least 630° C. and likely much higher.

High-temperature stability of composite electrodes, as determined by measuring electronic conductivity as a function of temperature and pretreatment conditions, indicates the temperature at which materials break up and conductivity is lost. The metal composition and structure will strongly affect the temperature stability in most if not all of the different materials being deposited. Accordingly, embodiments may include electroplating a more stable metal, such as Cr or Co, onto a Cu cermet to improve the structure and stability of the electrode.

In another exemplary embodiment, an electroplated electrode comprises a conventional Ni cermet, onto which a layer of Cr has been electroplated, with another layer of Ni electroplated onto the Cr layer (resulting in a Ni—Cr—Ni layering). In this embodiment, Cr forms an alloy with Ni and the Cr may move around; however, nichrome is an oxidation-resistant alloy with excellent high temperature properties. If the Ni and Cr remain segregated at the SOFC operating temperatures, the Cr may impart creep resistance and redox stability to the electrode.

In another exemplary embodiment, an electroplated electrode may comprise a Cu-ceria-YSZ cermet. In this embodiment, Cu primarily provides electronic conductivity and ceria provides catalytic activity (along with some mixed electronic and ionic conductivity). In this embodiment, the catalytic activity of the electrode may be further optimized by one of two approaches. The first approach is to use the interactions between a catalytic metal and the ceria to enhance the reducibility of the ceria. In essence, this is what occurs with the addition of precious metals to the electrode. A second approach for enhancing catalytic activity is to substitute ceria with a ceria-zirconia solid solution. Ceria-zirconia mixed oxides are known to exhibit better redox properties than ceria, and have electronic conductivities comparable to ceria. The ability to add the ceria to the YSZ in the electrode after high-temperature sintering is key to the preparation of these materials.

In one embodiment, the electroplating reaction mechanism is further controlled through the addition of additives to the plating solution. For example, the addition of chloride ions and PEG (polyethylene glycol) to an electrolyte bath inhibits copper deposition at the external surface of pores. When MPSA (3-mercapto-1-propanesulfonate) or SPS (3-sodiumsulfopropyl disulfide) is added as an accelerator to the Cl-PEG in the plating bath, deposition occurs preferentially in the cavities within the surface to be plated. BTA (benzotriazole) may be used as an alternative to MPSA or SPS. It is believed that BTA acts as an inhibitor at high concentrations and an accelerator at low concentrations, so that small concentrations of BTA diffuse into trenches and accelerate deposition, while large concentrations of BTA at the surface inhibit deposition.

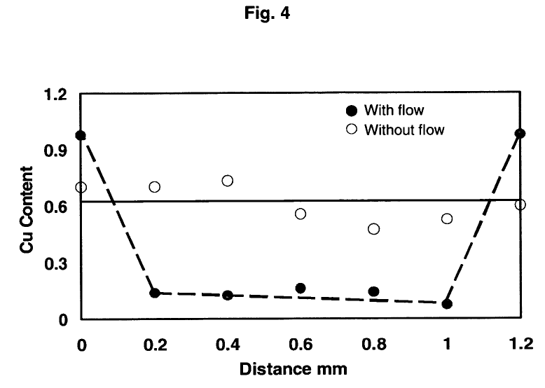

The uniformity of the electrodeposition also may be optimized by controlling processing conditions. For example, when Cu is electroplated into a Ni cermet, it is believed that three conditions lead to uniform plating onto the porous material. The first condition is the use of low concentrations of Cu salts in the plating bath. Dilute solutions lead to diffusional limitations at low current densities, since Cu must diffuse into the pores at the same rate as the electroplating occurs. Where convective flow is possible, this may not pose a problem since Cu ions may be brought into the porous substrate as fast as they plated out. For example, FIG. 4 shows EDS characterization of a composition in two Ni—YSZ cermets after electroplating with Cu. The filled circles show Cu content when electroplating is conducted using an optimal bath concentration (0.1 M Ce (NO₃)₂ and 0.5 M H₂SO₄). The unfilled circles show Cu content where convective flow is used. Even using a low current density, it is clear that most of the Cu plates out on the external surface. However, when the electrolyte solution is “flowed” through the Ni cermet during plating, it is possible to get very good distribution of Cu throughout the Ni cermet. However, convective flow is not possible when a dense electrolyte is covering one side of the cermet. Therefore, in order to use electroplating of Cu without convective flow, it is preferable to work with thin electrodes and very low currents to avoid diffusional limitations. A second condition leading to uniform Cu plating onto the porous material is the use of high concentrations of sulfuric acid in the bath. A third condition is the avoidance of concentration gradients of the Cu salt within the pores of the Ni cermet.

The process of Cr electrodeposition is more complex than Cu deposition. Several factors contribute to the efficiency of the Cr electroplating process. First, the electroplating is strongly dependent on the current density and is preferably carried out at high voltages. No plating occurs until a critical threshold current is achieved. Since the plating voltage may be ˜2 V, electrolysis occurs simultaneously with the Cr deposition, so that efficiency (number of Cr atoms plated per Coulomb transferred) is very low, ˜20%. The plating solution preferably has a high chromate concentration, avoiding the diffusion difficulties observed with Cu electrodeposition. Finally, the deposition depends on the surface areas of both the counter electrode and the electrode onto which the Cr is deposited. Despite the fact that Cr electrodeposition is more complicated, it is possible to deposit Cr uniformly within a Ni-cermet or a Cu-cermet by controlling these factors.

In one preferred embodiment, a method of preparing a SOFC electrode generally involves forming a porous electrode containing a conductive material and a dense electrolyte composite. The method then includes electrodepositing a conductive material into the porous electrode.

In another embodiment, the porous electrode containing a conductive material is prepared by mixing a conductive material and an electrolyte material with pore formers, and then depositing the mixture onto a separate electrolyte material. The two layers are then co-fired or cosintered to form a dense electrolyte and porous electrode containing a conductive material. The method then includes electrodepositing a conductive material into the porous electrode.

In another embodiment, the porous electrode containing a conductive material is prepared by depositing on an electrolyte material layer, a second electrolyte material containing pore formers, and then co-firing or co-sintering the two layers to produce a dense electrolyte layer and a porous layer. The method then includes adding a conductive material to or on the porous layer with a conductive material to form a porous electrode containing a conductive material, and then coating the electrode with a suitable material by electrodeposition. The conductive material can be added by any of a variety of techniques including impregnation, CVD, and electroless deposition.

In preparation of the porous electrode, the present embodiments are not limited to any particular material used for the electrolyte, anode, or cathode, nor are they particularly limited to their respective methods of manufacture. In the various embodiments, the starting porous electrode may be prepared using any known or later developed method. Upon reading the guidelines provided herein, those skilled in the art will be capable of preparing a porous electrode for use with the embodiments.

It is preferable that an electrode of the embodiments contains a good electronic conductor and an ionic conductor. Preferably, the ionic conductor is the same material used for the electrolyte. In accordance with the various embodiments, fabrication of an electrode starts by mixing and sintering oxides of the electrode components, followed by subsequent treatments as necessary. For example, a Ni—YSZ cermets may be prepared by high-temperature sintering of mixed NiO and YSZ powders. In this case, the best performance is achieved when the firing temperature is greater than 1300° C. to properly sinter the YSZ in the electrode to the YSZ in the electrolyte. As another example, LSM-YSZ cathodes may be prepared by sintering mixtures of LSM and YSZ that are screen printed onto the electrolyte. Preferably, the porous electrolyte contains a conductive material prior to electrodeposition.

It is preferable that the porous electrode includes a plurality of pores having a pore size of at least about 0.5 μm. Not all the pores need to have a pore size greater than about 0.5 μm, but is it preferred that more than 50%, preferably more than 60%, and most preferably more than about 75% of the pores have a pore size greater than about 0.5 μm. The pore size is determined by measuring the distance along the major dimension of the pore. It is preferred in the embodiments that a plurality of pores have a pore size greater than about 0.25 μm, and less than about 1.5 μm.

The porosity of the electrode prior to dispersing the ion conducting material typically is about 55 to about 75%. The porosity is measured by immersing the sintered product in water and comparing its weight after immersion with that prior to immersion, as described in Kim, H., et al., J. Am. Ceram. Soc., 85,1473 (2002). The difference yields the weight of water dispersed in the pores, which when divided by the density will yield the volume of the pores. The porosity then can be determined simply by dividing the volume of the pores by the total volume of the sintered product. Most preferably, the porosity of the sintered electrolyte product prior to dispersing the electronically conducting material is about 60%.

The porosity of the electrode after dispersing the ion conducting material can be anywhere from about 10% to about 75%, more preferably from about 10% to about 40% and most preferably from about 12% to about 30%. The porosity of the electrode will depend in part on the amount of electronically conducting material used.

As discussed previously, the electrochemical reaction in a SOFC or SOE electrode occurs only at the TPB, the region where the electronic conductor, the electrolyte, and the gas-phase come together. This concept has important implications for development of electrodes, in that many approaches for optimizing heterogeneous catalysts (e.g., increasing surface area, improved dispersion, etc.) are not effective, and may even be counterproductive. In the electrode, it is essential that each of the phases are “connected.” A good heterogeneous catalyst will only assist reaction if the active sites are simultaneously accessible to the gas phase, to the ion-conducting phase (which must be well connected to the electrolyte), and to the metallic phase. Typically, in high-performance electrodes, the zone of the TPB is increased by incorporating ion-conducting channels that extend from the electrolyte into the electrode. C. W. Tanner, K.-Z. Fung, A. V. Virkar, JECS, 22, 144 (1997); Virkar, A. V.; Fung, K. Z.; Tanner, C. W. U.S. Pat. No. 5,543,239 (1996); Fleig, J. J. Power Sources, 105, 228 (2002).

Connectivity of the electrode is a factor considered in the selection of a materials for use in a SOFC electrode. The high calcination temperatures required to establish the electrode microstructure and the connectivity with the electrolyte can lead to solid-state reactions with the electrolyte or between components in the electrode. For example, Cu may not be an appropriate material in a YSZ cermet because traditional methods used to prepare the cermets involve sintering at high temperatures, and CuO and Cu₂O melt at temperatures below that needed to sinter YSZ. In addition, despite the fact that cathodes based on Sr-doped LaFeO₃ (LSF) and LaCoO₃ (LSCO) can exhibit much better electrochemical performance, LSM-YSZ composites are the most commonly used material for SOFC cathodes because it is possible to use LSM at higher sintering temperatures without having solid-state reactions with the YSZ. H. He, Y. Huang, J. Regal, M. Boaro, J. M. Vohs, and R. J. Gorte, J. Am. Ceram. Soc., 87331 (2004); Y. Huang, J. M. Vohs, and R. J. Gorte, JECS, 151, A646-A651 (2004); Y. Huang, K. An, J. M. Vohs, and R. J. Gorte, JECS, 151 (2004).

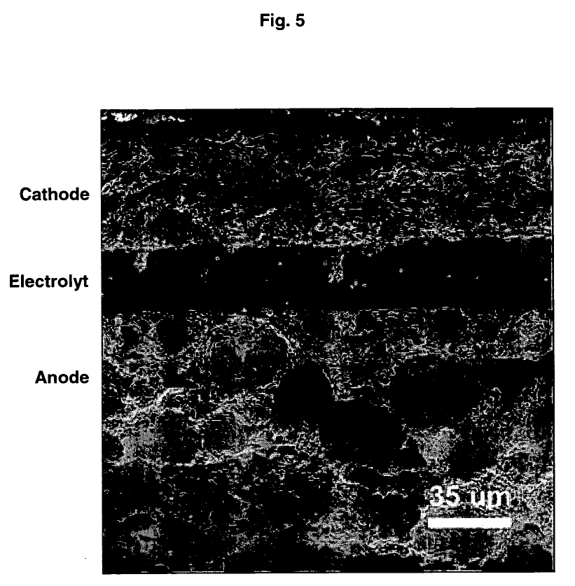

For example, the porous material and the dense electrolyte may be fabricated at the same time by tape-casting methods, such as by laminating two or more green tapes of YSZ. In this embodiment, porosity is achieved through the addition of organic pore formers in layers that are to be porous. The porosity and pore-size distribution can be tailored through the amount and type of pore former that is added to the green tapes. Optionally, structural components may be added to allow fabrication of large cells (100 cm²) with increased strength. FIG. 5 shows an SEM of the cross-section of the starting YSZ structure for a particular cell for which porous layers were incorporated on both sides of the dense layer to allow fabrication of both the anode and cathode by impregnation or other method capable of introducing a conductive material into a porous electrode framework.

Preferably, the porous electrode contains a conductive material prior to electrodeposition. The conductive material present in the electrode may be the same or different from the conductive material deposited by electrodeposition. The conductive material, as well as other electronic and catalytic components may be added to the porous material using any known technique, such as by conventional cermet electrode formation, impregnation, chemical vapor deposition (CVD), or electroless deposition. For example, the addition of the electronic and catalytic components may be accomplished by impregnation with soluble salts and low temperature synthesis. In general, the porous electrode is dipped in an aqueous solution of metal salts at room or low temperature. The anode is removed from solution and allowed to dry, thereby depositing salts in the porous electrode. For example, composite electrodes may be based on YSZ with Cu, Cu—Ni alloys, La_{0.8}Sr_{0.2}FeO₃ (LSF), and La_{0.8}Sr_{0.2}CoO₃ (LSCo). This method also may be used to make composite electrodes from other electrolytes, such as Sm-doped CeO₂ and Sc-doped ZrO₂.

As mentioned above, one method of providing a conductive material to the porous electrode prior to electrodeposition is impregnation of the porous electrode with a conductive material. Fabricating the electrolyte and porous electrode framework from the same material, followed by addition of the electronically conductive material to the porous electrode can help to solve the problem of mismatch of Coeffecient of Thermal Expansion (CTE) between the electrode and the electrolyte—a factor that limits the choice of materials that can be used for electrodes. The structure of the composite electrode is largely determined by the electrolyte material used for making the porous material into which the metallic and catalytic components are added. Therefore, the CTE of the electrode is much closer to that of the electrolyte than would be expected from a combination of the materials used. The impregnation methods described herein all can be used to introduce a conductive material into the porous electrode prior to electrodeposition.

One or more materials such as metals may be deposited in or on the porous electrode prior to electrodeposition using one or more alternative methods, in addition to or as an alternative to impregnation. For example, metals may be depositied on an electrode in a layer-by-layer manner by using chemical vapor deposition (CVD). CVD may be used to deposit high-quality Cu films inside a porous YSZ structure using Cu[CH₃COCH═C(O—)CH₃]₂.H₂O. CVD enables one to deposit Cu more uniformly over the surface of a second metal than would be possible using impregnation with metal salts. In principle, one may even be able to form layered structures, with alternating layers of different metals. As with electrodeposition, CVD allows metals to be deposited directly, without the need for subsequent reduction. Electroless deposition is another useful method for adding metals to an electrode. For example, in the case of Cu, the metal salt is reduced to Cu by oxidation of formaldehyde in the plating solution. A catalyst, such as Pd or Ag, is used to initiate the process. An advantage of this method is that the metal is deposited only where the catalyst is present. The catalyst may be incorporated initially in those places where plating is desired, such as within the pores of the electrode and not outside the structure. Unlike electroplating, electroless deposition of Cu can be done at high pH, with Cu ions kept in solution using a chelating agent. This could have advantages for avoiding other components (e.g., ceria) dissolving into the acidic plating solutions. In summary, not only are these methods cost effective, but researchers have also succeeded in using these methods to make nanocomposites, using mixtures of both Cu and Ni and mixtures of Cu and Co, with layered and other ordered structures of various shapes and sizes. Therefore, one can plate metals, such as Cr, that are difficult to incorporate by impregnation due to the difficulty of reducing the oxide. Again, the above-described methods are suitable for forming a porous electrode containing a conductive material, which then can be electroplated in accordance with the embodiments described herein.

Another feature of an embodiment includes a SOFC that comprises the electrode prepared by the method of the embodiments. The electrode may be either a cathode, or an anode of the SOFC, or both. Preferably, the SOFC includes an air electrode (cathode), a fuel electrode (anode), and a solid oxide electrolyte positioned at least partially between these two electrodes. In a SOFC, the electrolyte is in solid form. Any material now known or later discovered can be used as the electrolyte material. Typically, the electrolyte is made of a nonmetallic ceramic, such as dense yttria-stabilized zirconia (YSZ) ceramic, the anode is comprised of a nickel cermet, copper oxide and ceria, or LSC. In the solid oxide fuel cell, hydrogen or a hydrocarbon is commonly used as the fuel and oxygen or air is used as the oxidant. Other electrolyte materials useful in the embodiments include Sc-doped ZrO₂, Gd— and Sm-doped CeO₂, and LaGaMnOx.

The SOFC of the present embodiments can include any solid electrolyte and any anode or cathode made using techniques disclosed in the art. The present embodiments are not limited to any particular material used for the electrolyte, anode, or cathode, nor are they particularly limited to their respective methods of manufacture. The embodiments are not limited to any particular number of fuel cells arranged in any manner to provide the requisite power source.

In a similar manner, the embodiments are not particularly limited to any design of the SOFC. Several different designs for solid oxide fuel cells have been developed, including, for example, a supported tubular design, a segmented cell-in-series design, a monolithic design, and a flat plate design. All of these designs are documented in the literature. See, e.g., Minh, “High-Temperature Fuel Cells Part 2: The Solid Oxide Cell,” Chemtech., 21:120-126 (1991); Minh, et al., Science and Technology of Ceramic Fuel Cells, Elsevier, p. 255 (1995); U.S. Pat. No. 5,273,837 to Aitken, et al.; U.S. Pat. No. 5,089,455 to Ketcham, et al.; U.S. Pat. No. 5,190,834 to Kendall (the disclosures of which are incorporated herein by reference in their entirety).

Fuel cells that are designed for direct oxidation of methane have slightly different requirements than those designed for oxidizing higher hydrocarbon fuels. These requirements affect the material selection criteria and method of preparation of an electrode for the fuel cell. For example, oxidation of CH₄ requires higher temperatures or more active catalysts than are required for oxidation of higher hydrocarbons. Therefore, it is preferable that materials selected for use in electrodes involved in the direct-utilization of CH₄ are stable to higher temperatures and have enhanced catalytic activity for CH₄ activation within the electrode, preferably without using precious metals.

Suitable materials for use in electrodes involved in the direct-utilization of CH₄ include alloy and bimetallic systems. By providing two or more materials in a layered structure, such as by electrodeposition, the resultant system may have desirable properties that neither material exhibits alone. For example, by utilizing Cu (which has relatively low melting temperature, and low catalytic activity) with a metal like Ni or Co (which have much higher melting temperature, and higher catalytic activity), whereby the Cu is electrodeposited on the Ni or Co, the resultant system may have improved thermal stability and better catalytic properties, while still maintaining stability against the formation of carbon. Examples of other bimetallic systems that are suitable for this application include mixtures of Ni with Sn, in which Sn passivates the carbon formation in Ni; Cr and Ni; and Cu with Cr, in which Cr enhances the thermal stability of Cu.

Bimetallic systems exhibit two types of interactions that may affect the properties of the electrode. First, the bimetallic system may form a single-phase disordered solution over the entire range of compositions, with melting points that vary almost linearly with metal composition. Thus, the surface composition of the alloy, and therefore the tendency to form carbon upon exposure to hydrocarbons, depends on treatment conditions. For example, Cu and Ni form such a solution, but it has been found that Cu—Ni alloys having more than approximately 20 wt % Ni (considering the metal phase only) are unstable toward carbon formation in dry CH₄ at 800° C. “Cu—Ni Cermet Anodes for Direct Oxidation of Methane in Solid-Oxide Fuel Cells”, H. Kim, C. Lu, W. L. Worrell, J. M. Vohs, and R. J. Gorte, Journal of the Electrochemical Society 149 (2002) A247-A250.

Cu and Co do not form solutions to any appreciable extent and XRD patterns of bimetallic electrodes show two phases. Cu advantageously tends to migrate onto the surface of the Co because of its lower surface energy, passivating the mixture towards carbon formation. The effectiveness with which Cu does this is demonstrated in FIG. 3, which shows a series of metal-YSZ composites that were exposed to dry CH₄ at 800° C. for 2 hours: sample (a) contains 100% Cu, sample (b) contains 90% Cu, and 10% Co; sample (c) contains 70% Cu, and 30% Co; sample (d) contains 50% Cu, and 50% Co; sample (e) contains 10% Cu, and 90% Co; and sample (f) contains 100% Co. As expected, the Co-only cermet (sample (f)) was essentially destroyed by this treatment, while sample (e), which had as little as 10 wt-% Cu appeared almost carbon free. Furthermore, a fuel cell with a 50 wt-% Cu—Co cermet anode (like sample (d)) exhibited stable performance in dry CH₄ for at least 500 hours at 800° C. and showed improved electrochemical performance over Cu-only anodes. While not intending to be bound by any specific theory in understanding how Co can be covered by Cu and still provide catalytic properties that enhance performance, it is believed that the small amount of Co present in the Cu-rich phase (˜2 atom % based on the phase diagram), is responsible for the enhanced performance. However, the apparent instability of Cu—Co anodes in liquid fuels is possibly an effect of the 2 mol % Co in the Cu-rich phase.

The use of bimetallics in electrodes also may involve the formation of intermetallic compounds, like Ni₃Sn. These materials have very interesting physical and mechanical properties and could well be useful for fuel cell applications. For example, the presence of a catalytic metal at the surface (e.g., Ni) may increase performance if carbon formation can be avoided-which may well be suppressed in the intermetallic compounds. While the suppression of carbon is promising, the formation of intermetallic compounds within the porous electrode may prove to be challenging because the reduction of some oxides is difficult.

In addition to optimized material selection, electrodes involved in the direct-utilization of CH₄ may benefit from modified fabrication procedures that are designed to control the structure of the catalytic and metallic components of the electrode on the nanometer length scale. For example, by using electrodeposition, it may be possible, by controlling the structure, to improve both the performance and the stability of electrodes that are based on these metals. In addition, the use of electrodeposition allows the placement of metals which are difficult to reduce from their salt (such as Cr), into the electrode in their reduced metallic form.

The embodiments now will be explained with reference to the following non-limiting examples.

### EXAMPLES

### Example 1

### Electrodeposition of Cu

In this example, a Cu-cermet electrode was prepared using impregnation and electrochemical deposition of Cu into a YSZ slab. Initially, a solution of 4.49 M CuNO₃ was impregnated into a porous YSZ slab. After each impregnation step the sample was calcined at 450° C. The slab was impregnated to an initial copper loading of about 15 wt %. The sample was then reduced in hydrogen at 450° C. Copper was then electrochemically deposited into the slab. The formulation of the aqueous copper bath was as follows: 1.0 M CuSO₄, 0.5 M H₂SO₄, 3 g/L PEG (polyethylene glycol), and 0.5 g/L NaCl. The bath was at ambient temperature and magnetically stirred. A copper wire was used as the anode and a silver wire was attached to the slab with silver ink. The slab was then covered in wax leaving only the ends of the slab open to the bath. The deposition was carried out at a constant current of ˜4 mA for 4 days. The dimensions of the slab were 0.33 cm by 0.66 cm by 1.50 cm and the sample was about 70% porous. A sample prepared in this manner resulted in a copper loading of 57 wt %.

### Example 2

### Electrodeposition of Cu

In this example, a Cu-cermet electrode was prepared using impregnation and electrodeposition of Cu into a YSZ slab. The starting electrolyte mateial was a porous YSZ slab, nearly 1 cm thick. The method involved depositing 10 wt % Cu initially through normal impregnation, then electrodepositing in a solution of 1.0 M CUSO₄, 0.5 M H₂SO₄, 3000 mg/L PEG, and 500 mg/L of NaCl. Using this method, the resultant electrode contained nearly 60 wt % Cu, where nearly all of the Cu was inside the material.

### Example 3

### Electroless Deposition

In this example, copper was deposited into a porous YSZ material using electroless deposition. First, the sample was impregnated with a catalyst. A solution of 0.3 M AgNO₃ and 50 ml/L NH₄OH was impregnated into the sample. The impregnation occurred in one step with about 0.3 mL of the solution. This resulted in about one mg of Ag in the sample. The sample was subsequently dried and washed down with 1.5 M HNO₃ several times. The impregnated solution was washed down to the bottom of the sample in order for copper to grow throughout. The AgNO₃/NH₄OH solution forms ammoniacal silver (I) ions and the silver ions were reduced in the copper deposition bath. Thereafter, copper was deposited onto the sample using electroless deposition. The formulation of the aqueous copper bath was as follows: 0.05 M CuSO₄, 0.08 M EDTA, 8 mUL CH₂O (37 wt %), and the pH was adjusted to 13 with NaOH. The bath was at ambient temperature and air was bubbled through the solution. The sample was left in the bath until the surface of the sample was covered. A sample prepared in this manner resulted in a copper loading of 4 wt %.

### Example 4

### Electrodeposition of Cu into a Porous Ni—YSZ Anode

In this example, Cu was deposited on a Ni—YSZ cermet using electrodeposition. In this example, the thickness of the layer was on the order of 2 nm, which is much smaller than the pore dimensions of the Ni-cermet, making it possible to uniformly deposit metals, so long as the concentrations of ions and the potential of the solution within the porous electrode can be maintained reasonably constant. This system avoided ion concentration gradients in the solution by allowing gravity to force fluid through the cermet.

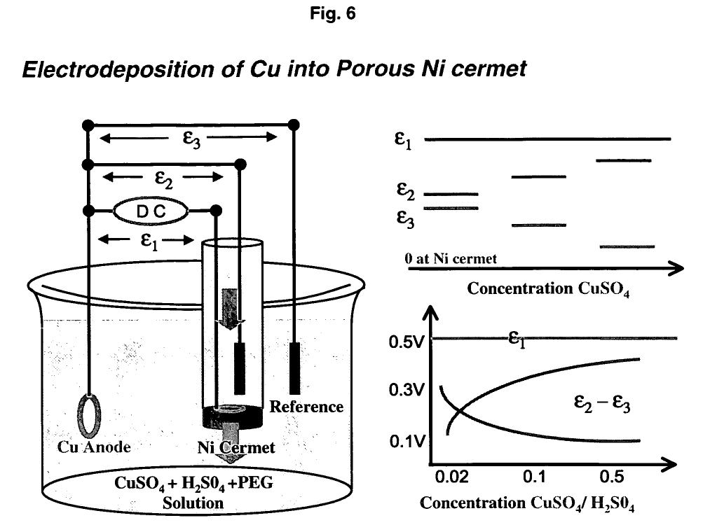

The potential in the solution on the opposite side of the Cu anode was maintained at a value close to that of the solution on the same side as the Cu anode so long as a low concentration of Cu(SO₄) and high concentration of H₂SO₄ were used. FIG. 6 shows a schematic of an the system used to measure the solution potential inside the pores. In this apparatus, the potential of the fluid was measured by a reference placed on either side of the porous Ni cermet.

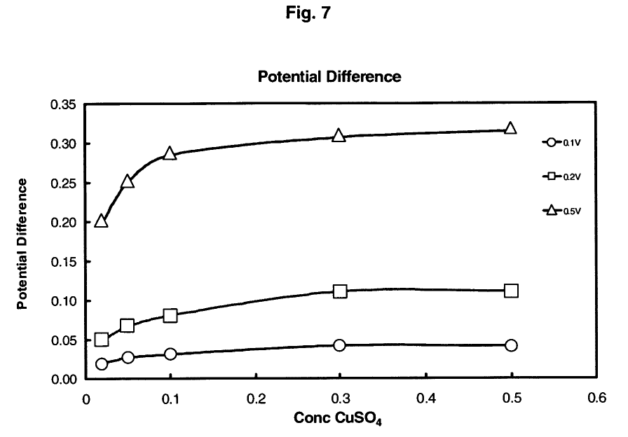

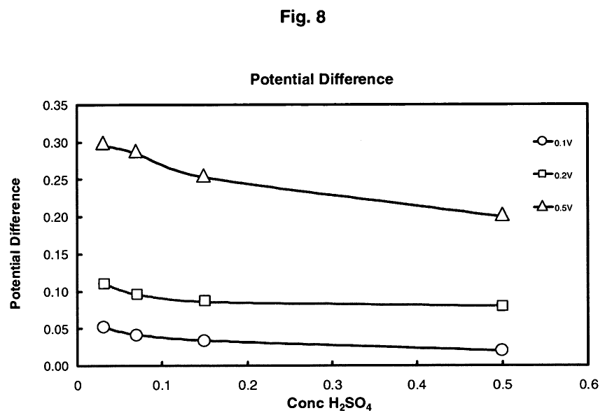

Actual experimental data for the potential difference between the two reference electrodes, for three “working” potentials (defined here as the potentials between the anode (the Cu electrode) and the cathode (the Ni cermet), are shown in FIG. 7 for different Cu(SO₄) and FIG. 8 H₂SO₄ concentrations.

Inhibitors (sulfide compounds) were also added to the solution to make deposition more uniform. However, these did not affect the potential difference between these two reference electrodes.

In this example, the electrodeposition process was successful at depositing Cu equal to the amount of Ni (33 wt % Ni, 33 wt % Cu, and 33 wt % YSZ) within the original Ni cermets that were as much as 1.5 mm thick (by use of upright tube).

### Example 5

### Cu—Ni Cermet Exposure to Methane

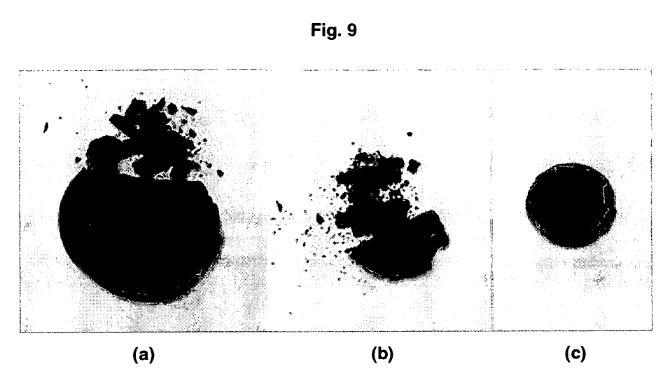

In this example, three cermets were prepared for testing: one Ni-cermet, and two Cu-electroplated Ni-cermets. The electroplated samples were prepared by electrodepositing Cu into a Ni cermet at 50 mA, using a 0.02M CuSO₄+0.5M H₂SO₄ solution with PEG. The three samples were exposed to methane at 800° C. for 3 hours. FIG. 9 shows the results of this exposure. In FIG. 9, sample (a) is the Ni cermet that was not electroplated, sample (c) is a Cu—Ni cermet (50 wt % Ni, 50 wt % Cu, excluding the YSZ, Example 4), and sample (b) is a Cu—Ni cermet (75 wt % Ni, 25 wt % Cu, excluding the YSZ). The photographs show that sample (a), the Ni cermet without Cu, greatly expanded in size when exposed to methane due to the formation of Ni—C (all of the cermet samples were initially the same size as sample (c) on the right). In contrast, sample (c), with equal Cu and Ni contents, showed carbon deposition only at the edges where some Ni was exposed. This proves that the Cu was uniformly deposited onto the Ni in sample (c).

### Example 6

### Cr Electrodeposition of Ni-Cermet

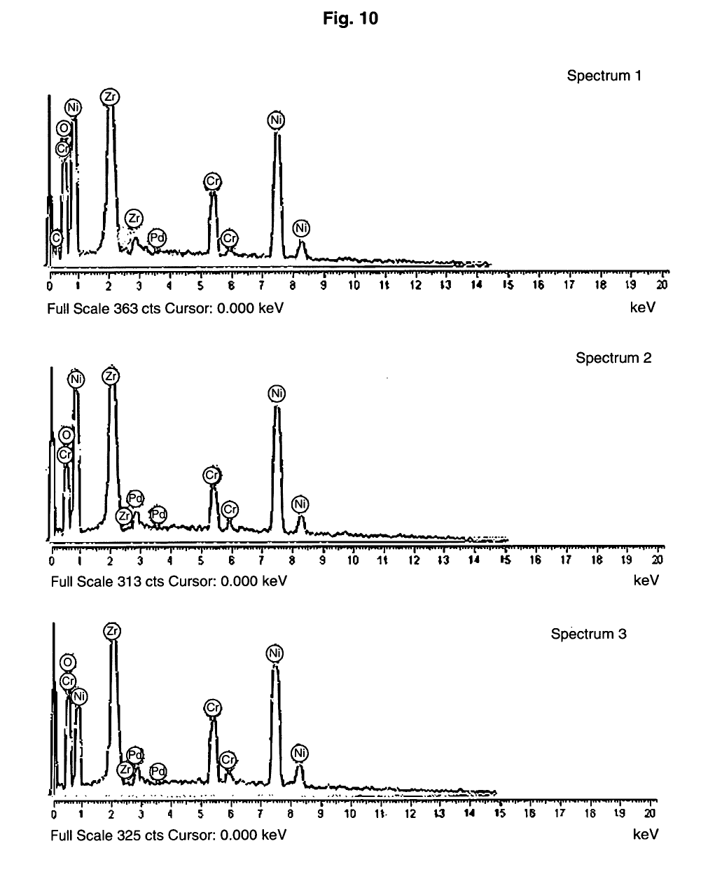

This example demonstrates uniform electrodeposition of Cr onto Ni-cermet. Cr deposition was conducted at 20 mA and 2V in 3.5M CrO₃ and 0.5M H₂SO₄. FIG. 10 shows EDS data at various distances into an exemplary Ni cermet following electrodeposition. The EDS results show that the Cr concentration is very uniform in the Ni cermet.

### Example 7

### Cr Electrodeposition of Cu-Cermet

In this example, Cr was electroplated onto Cu cermets. For testing purposes, electrolyte-supported cells were used, with a 60-micron thick electrode. The cells contained equal weights of Cu and Cr. In one cell, Cr was only present at the external surface. These electrolyte-supported cells were made without ceria, so that essentially all conductance would be from the metal phase. Because any metal that is not in the pores but at the external surface tends to skew the results, the ohmic resistance of the actual fuel cells was measured to determine conductivity loss.

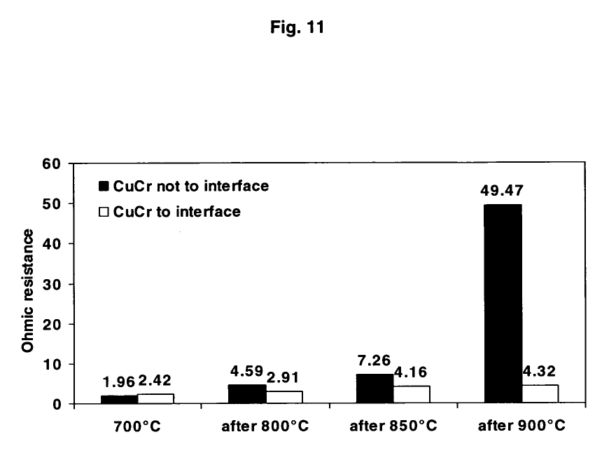

FIG. 11 shows the ohmic resistance for the two cells. The resistance is determined from impedance spectra at 700° C. in humidified H₂, following pretreatment for one hour at various temperatures. For one cell, the Cr was only present at the external surface and did not enhance conductivity throughout the anode cermet. What the data shows is that cell which had only Cu present at the electrolyte interface exhibited serious sintering beginning at 800° C. By 900° C., the anode was essentially dead, as demonstrated by the high ohmic resistance of the cell. Sintering in this case occurred at a slightly lower temperature than normal because the cell did not contain ceria; however, a similar loss in performance was observed for Cu-ceria-YSZ cermets at 900° C. By contrast, the ohmic resistance of the cell in which Cr was present all the way to the electrolyte interface remained reasonably low, even after the 900° C. treatment.

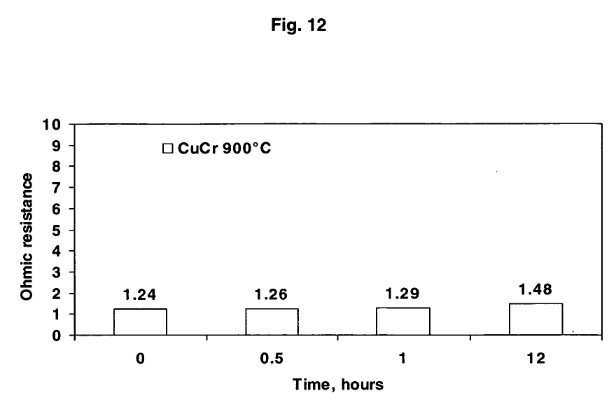

To determine if there was a time dependence to the stability, the cell was held with the Cu—Cr anode in dry H₂ at 900° C. for varying lengths of time to see if the ohmic resistance would increase. This data is shown in FIG. 12. The data suggest that the conductivity of these anodes remains reasonably good at this high temperature.

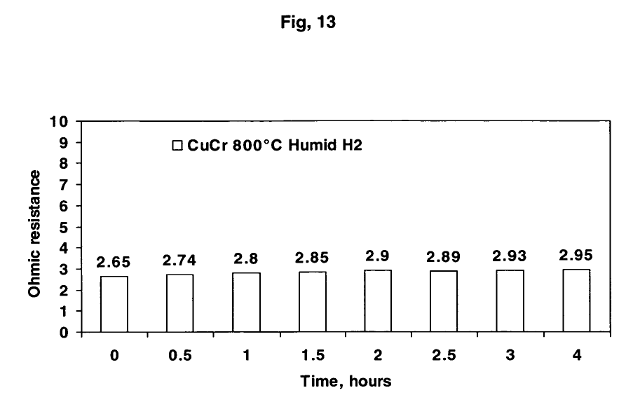

To examine the effect of steam, the Cu—Cr cell was exposed to humidified (20% water) H₂ at 800° C. for various lengths of time. The results of this test are shown in FIG. 13. The data shows that the cell did not appear to be badly affected by steam. However, in most cases, it would be expected that it would be necessary to electroplate Cu onto the Cr in order to prevent oxidation of the Cr by steam.

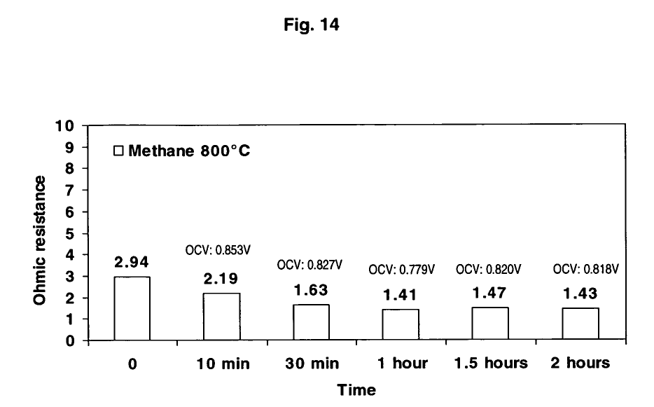

Finally, while it was not expected that Cr would be a catalyst for carbon formation, the Cu—Cr cell was held in dry methane at 800° C. for 24 hours and measured the ohmic resistance as a function of time. Following the end of the experiment, physical examination did not show visible evidence of carbon formation and the cell maintained an open-circuit voltage of 1.1 V in H₂, indicating that no damage had occurred to the cell electrolyte. The ohmic resistance of the cell decreased with time, as shown in FIG. 14, suggesting that there was likely some carbon formation in the anode, although it did not appear to be serious. The fact that the conductivity increased showed that the Cr layer was not destroyed by forming a carbide.

While the invention has been described with reference to particularly preferred embodiments and examples, those skilled in the art recognize that various modifications may be made to the invention without departing from the spirit and scope thereof.

What is claimed is:

1. A method of making an electrode for use in a solid oxide fuel cell, said method comprising:
providing a porous electrode material comprising a first conductive material and an electrolyte; and
electrodepositing on the porous electrode material a second conductive material, wherein the second conductive material is disposed at least partially within the pores of the porous electrode material.

2. The method of claim 1, wherein the porous electrode material comprises a Ni—YSZ cermet.

3. The method of claim 1, wherein the porous electrode material comprises a Cu—YSZ cermet.

4. The method of claim 1, wherein the porous electrode material comprises a LSM-YSZ cermet.

5. The method of claim 1, wherein the first conductive material is Ni and the second conductive material is Cu.

6. The method of claim 1, wherein the first conductive material is Ni and the second conductive material is Cr.

7. The method of claim 1, wherein the first conductive material is Cu and the second conductive material is Cr.

8. The method of claim 1, wherein the first conductive material is Ni and the second conductive material is Co.

9. The method of claim 1, wherein electrodepositing on the porous electrode material a second conductive material comprises:
providing a plating bath comprising a salt of the second conductive material;
immersing the porous electrode in the plating bath;
providing a negative charge to the porous electrode.

10. The method of claim 9, wherein the plating bath comprises a solution of 1.0 M CUSO₄ and 0.5 M H₂SO₄.

11. The method of claim 9, wherein the plating bath comprises at least one additive to inhibit deposition of the second conductive material at the external surface of the pores of the porous electrode.

12. The method of claim 11, wherein the additive comprises a mixture of chloride ions and polyethylene glycol.

13. The method of claim 12, wherein the plating bath further comprises 3-mercapto-1-propanesulfonate, 3-sodiumsulfopropyl disulfide, benzotriazole, or combinations or mixtures thereof.

14. The method of claim 1, further comprising:
electrodepositing on the porous electrode material at least one additional conductive material.

15. The method of claim 1, wherein providing the porous electrode comprises:
providing a mixture of the first conductive material and a first electrolyte material;
depositing the mixture onto a second electrolyte material;
co-sintering the mixture and the second electrolyte material to form the porous electrode comprising the first conductive material and a dense electrolyte.

16. The method of claim 1, wherein providing the porous electrode comprises:
providing a first electrolyte layer comprising an electrolyte material and a pore former;
depositing a second electrolyte layer on the first electrolyte layer;
co-sintering the first and second electrolyte layers to produce a porous electrode comprising a dense electrolyte layer and a porous layer; and
providing the porous later with a conductive material.

17. The method of claim 16, wherein providing the porous layer with a conductive material comprises impregnating the porous layer with a conductive material.

18. The method of claim 16, wherein providing the porous layer with a conductive material comprises depositing the conductive material on the porous layer using chemical vapor deposition.

19. The method of claim 16, wherein providing the porous layer with a conductive material comprises depositing the conductive material on the porous layer using electroless deposition.

20. An electrode prepared by the method of claim 1.

21. A method of making a solid oxide fuel cell comprising:
providing a cathode;
providing an anode;
providing an electrolyte;
disposing the electrolyte at least partially between the anode and cathode;
wherein at least one of providing a cathode and providing an anode comprises:
forming a porous electrode containing a first conductive material and a dense electrolyte composite; and
electrodepositing on the porous electrode material a second conductive material, wherein the second conductive material is disposed at least partially within the pores of the porous electrode material.

22. A solid oxide fuel cell prepared by the method of claim 21.
